(19) United States
(12) Patent Application Publication
(10) Pub. No.: US 2015/0055373 A1
(43) Pub. Date: Feb. 26, 2015

(54) LIGHT GUIDE PLATE AND METHOD FOR MANUFACTURING SAME

(71) Applicant: HON HAI PRECISION INDUSTRY CO., LTD., New Taipei (TW)

(72) Inventor: YUNG-CHANG TSENG, New Taipei (TW)

(21) Appl. No.: 14/467,291

(22) Filed: Aug. 25, 2014

(30) Foreign Application Priority Data
Aug. 23, 2013 (TW) 102130212

(51) Int. Cl. F21V 8/00

(52) U.S. Cl. CPC G02B 6/0038; G02B 6/0065
USPC 362/620; 362/619; 264/1.24

(57) ABSTRACT

A light guide plate includes a light incident surface, a bottom surface connected to the light incident surface, and a light output surface facing away from the bottom surface. The light output surface is a roughened surface. A number of microstructures are formed on the light output surface. A method for making the light guide plate is also described.

### FIELD

The subject matter herein generally relates to illumination by light guide.

### BACKGROUND

A light guide plate includes a light output surface and a bottom surface opposite to the light output surface. A number of microstructures are formed on the bottom surface. The microstructures change transmission direction of light and make the light emitted out of the light guide plate through the light output surface more uniform.

### BRIEF DESCRIPTION OF THE DRAWINGS

Implementations of the present technology will be described, by way of example only, with reference to the attached figures.

FIG. 1 is an isometric view of an example of a light guide plate.

FIG. 2 is a cross-sectional view of the light guide plate of FIG. 1.

FIG. 3 is an enlarged view of section III of FIG. 2.

FIG. 4 is a flowchart of an example method for manufacturing the light guide plate of FIG. 1.

FIG. 5 is a cross-sectional view of a mold assembly for manufacturing the light guide plate of FIG. 1.

FIG. 6 is a cross-sectional view of an insert portion of the mold assembly of FIG. 5.

FIG. 7 is an enlarged view of section VII of FIG. 6.

FIG. 8 is a view illustrating the mold assembly of FIG. 5 manufacturing the light guide plate of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to mean essentially conforming to the particular dimension, shape, or other feature that is modified such that exactness does not apply. For example, “substantially cylindrical” means that the object resembles a cylinder, but can have one or more deviations from a true cylinder. The term “comprising,” means “including, but not necessarily limited to” and specifically indicates open-ended inclusion or membership in the so-described combination, group, series and the like. The references “a plurality of” and “a number of” mean “at least two.”

The present disclosure is described in relation to a method for manufacturing a light guide plate. A light guide plate includes a light incident surface, a bottom surface, and a light output surface. The light incident surface is connected to the bottom surface. The bottom surface and the light output surface are positioned at opposite sides of the light guide plate, and the bottom surface is substantially parallel to the light output surface. The light guide plate includes a number of microstructures. The microstructures are a number of prisms in strips. A number of prisms are formed on the light output surface. The stripes of prisms are parallel with each other. Portions of the light incident surface between adjacent prisms are defined as a roughened region.

The present disclosure is described in relation to a method for manufacturing a light guide plate. The method comprises: providing a mold assembly, an insert fixed on the mold, the mold including a male mold, a female mold, and an insert. The male mold is fixed to the female mold to form a receiving cavity, the female mold defines a through hole at a side thereof, the insert is received in the cavity and is attached to the male mold, the insert and the male mold cooperatively form a molding cavity. The through hole is in communication with the molding cavity and a melted transparent material is injected into the molding cavity then cooling to form the light guide plate.

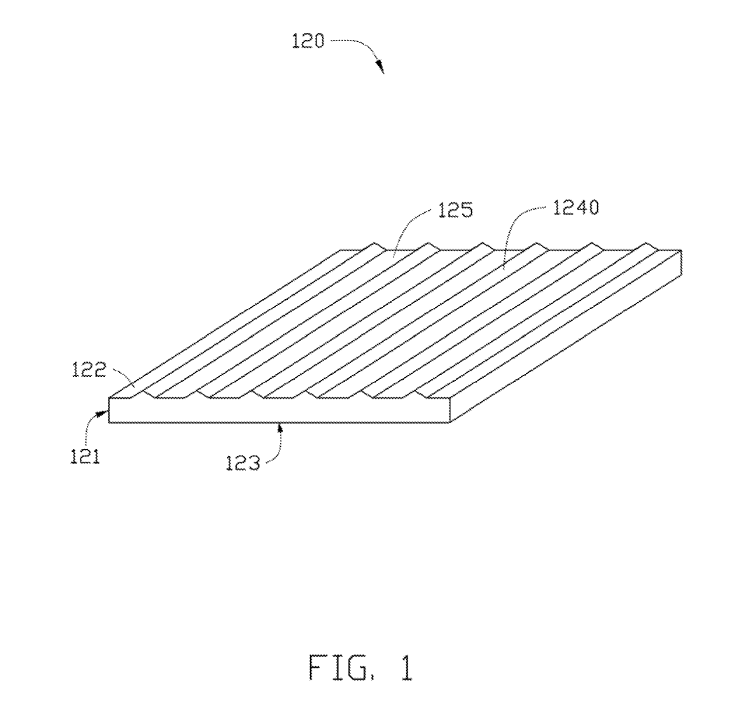

FIG. 1 illustrates a first example embodiment of a light guide plate 120. In this embodiment, the light guide plate 120 is a side type light guide plate. In detail, the light guide plate 120 includes a light incident surface 121, a light output surface 122, and a bottom surface 123. The light incident surface 121 is connected to the bottom surface 123 and the light output surface 122. The bottom surface 123 and the light output surface 122 are positioned at opposite sides of the light guide plate 120, and the bottom surface 123 is substantially parallel to the light output surface 122. The light guide plate 120 also includes a number of microstructures. The microstructures are a number of stripes of prisms 1240. The stripes of prisms 1240 are formed on the light output surface 122. The stripes of prisms 1240 are parallel with each other. Portions of the light incident surface 121 between adjacent stripes of prisms 1240 is defined as a roughened region 125.

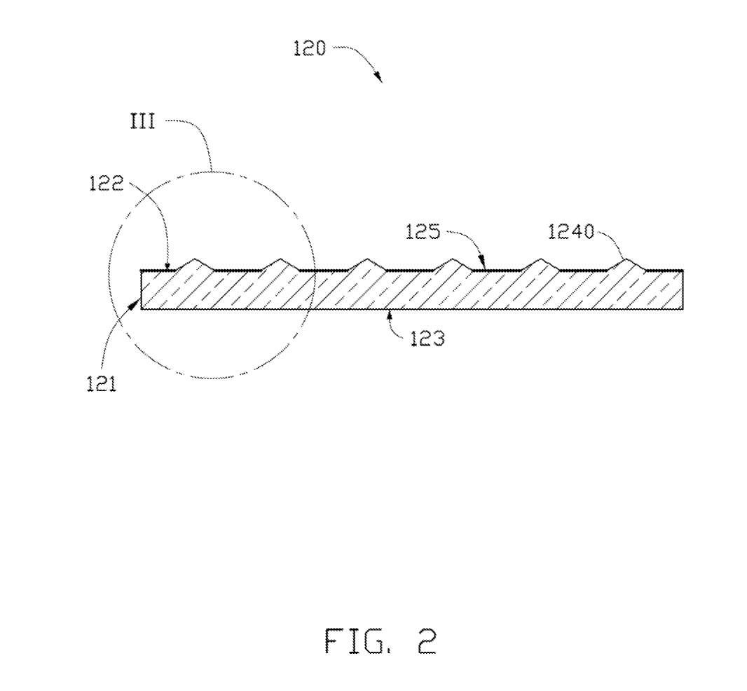

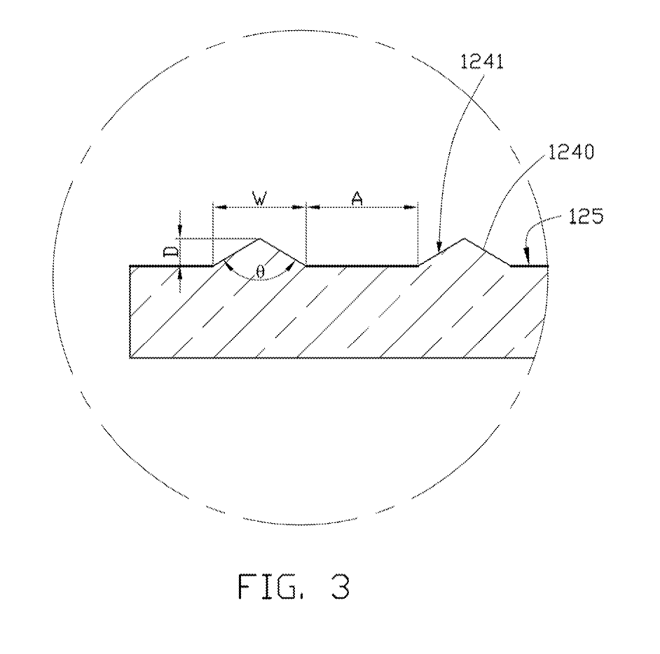

FIGS. 2-3 illustrate that a cross section of each of the prisms 1240 is an isosceles triangle. The apex angle θ of the isosceles triangle is about 130°. The width W of the base of the cross section of the prism 1240 is about 21.44 micrometers (um). The height D of the cross section of the prism 1240 is about 5 um. The distance A between adjacent prisms 1240 is about 28.56 um. That is, the width W of the base of the cross section of the prism 1240 is less than the distance A between two adjacent prisms 1240.

In this embodiment, the light guide plate 120 is made of transparent material, such as polymethyl methacrylate (PMMA), polycarbonate (PC), methylmethacrylate styrenecopolymer (MS), polyethylene terephthalate two ester (PETG), polystyrene (PS) or a mixture of the above materials.

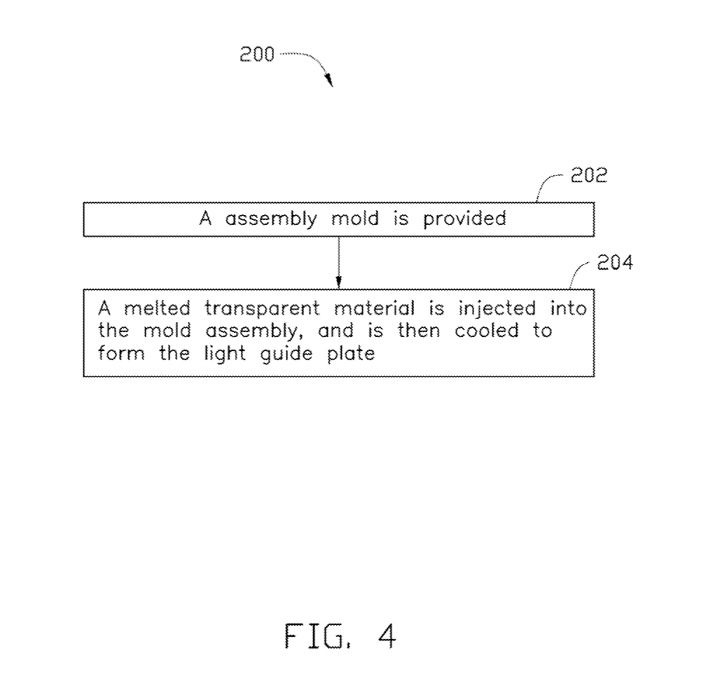

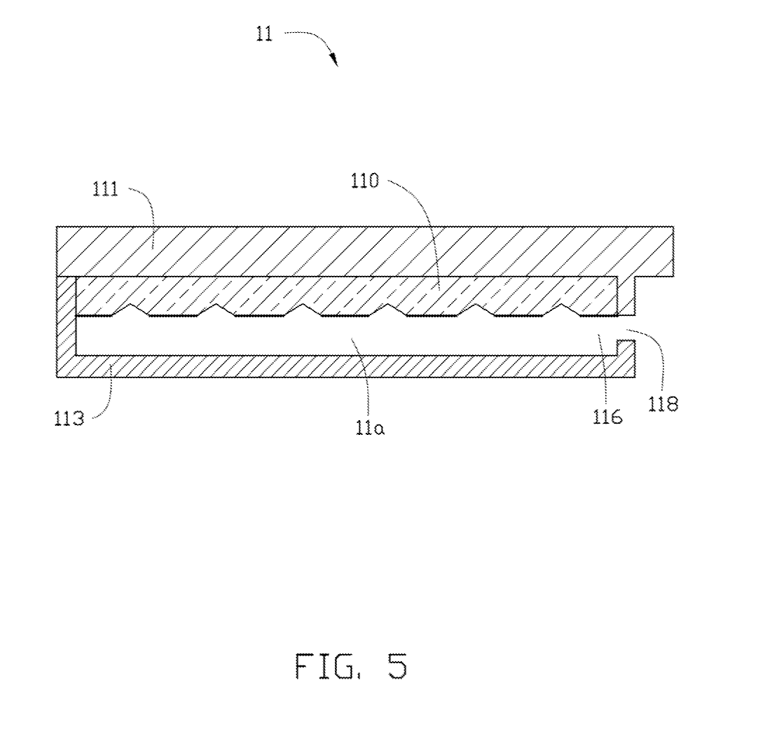

FIG. 4 shows a flowchart presented in accordance with an example embodiment. The example method 200 for making a light guide plate 120 is provided by way of an example, as there are a variety of ways to carry out the method. The method 200 described below can be carried out using the configuration of the mold assembly 11 illustrated in FIG. 5, for example, and various elements of these figures are referenced in explaining example method 200. Each block shown in FIG. 4 represents one or more processes, methods, or subroutines carried out in the exemplary method 200. Additionally, the illustrated order of blocks is by example only and the order of the blocks can change. The exemplary method 200 can begin at block 202.

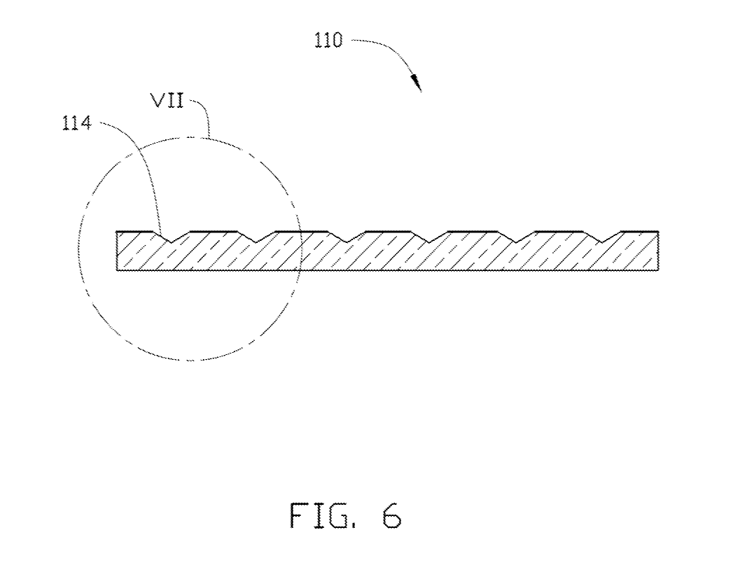

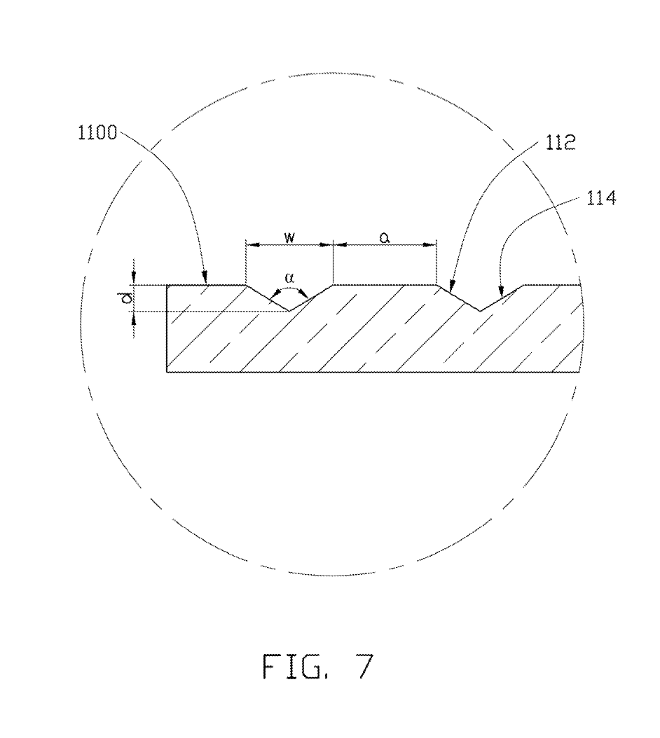

At block 202, a mold assembly 11 is provided. FIGS. 5 and 6 illustrate the configuration of the mold assembly 11. The mold assembly 11 includes a male mold 111, a female mold 113, and an insert 110. The male mold 111 is fixed to the female mold 113 to form a receiving cavity 11a. The female mold 113 defines a through hole 118 at a side thereof. The insert 110 is received in the cavity 11a and is attached to the male mold 111. The insert 110 and the male mold 113 cooperatively form a molding cavity 116. The through hole 118 is in communication with the molding cavity 116. FIGS. 6 and 7 shows that the insert 110 includes a molding surface 1100 and a number of micro-recesses 114 defined in the molding surface 1100. In this embodiment, each of the micro-recesses 114 is substantially a V-shaped cutout. The micro-recesses 114 are precision machined and are parallel with each other. Portions of the molding surface 1100 between adjacent micro-recesses 114 are roughened regions. The roughened regions are formed by grinding. A cross section of each of the micro-recesses 114 is substantially an isosceles triangle. Two inner surfaces 112 of the micro-recesses 114 are connected to each other. The inner surfaces 112 of the micro-recesses 114 are smooth and flat.

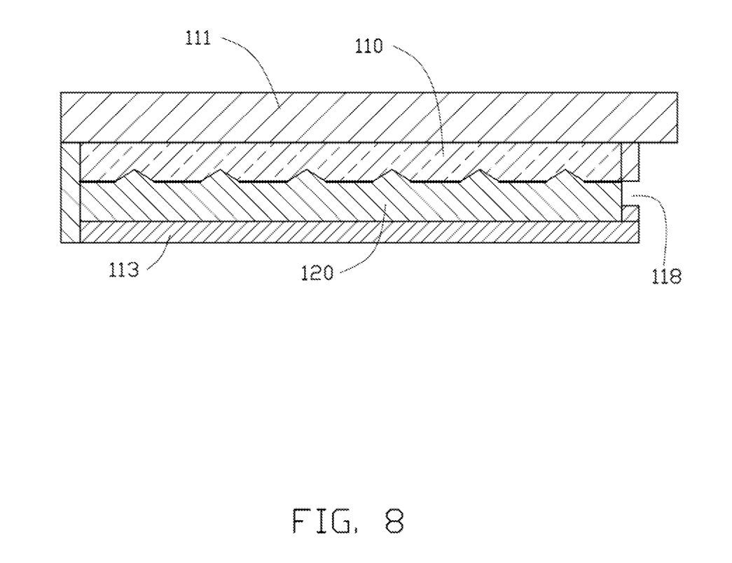

FIG. 8 illustrates that the distance a between two adjacent micro-recesses 114 is about 28.56 um. The depth d of the micro-recesses 114 is about 5 um. The width w of the base of cross section of the micro-recesses 114 is about 21.44 um. The base angle α of the isosceles triangle is about 130°.

At block 204, a melted transparent material is injected into the molding cavity 116, and cooled to form the light guide plate 120. FIG. 8 illustrates that the configuration of the light guide plate 120 is the same as that of the light guide plate of the first example. In detail, the melted transparent material is injected into the molding cavity 116 through the through hole 118. The molding surface 1100 corresponds to the formation of the light output surface 122. A number of micro-recesses 114 correspond to formation of the prisms 1240.

In an alternative embodiment, the inner surfaces 112 of the micro-recesses 114 can be roughened such that the outer surfaces 1241 of each of the prisms 1240 will be roughened.

In another embodiment, a cross-section of each of the microstructures on the light output surface 122 can be substantially arc-shaped. Accordingly a cross section of each of the micro-recesses 114 will be substantially arc-shaped.

The present disclosure only provides examples. Many details are often found in the art such as the other features of a light guide plate. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

1. A light guide plate comprising:
a light incident surface;
a bottom surface connected to the light incident surface; and
a light output surface, the light output surface and the bottom surface positioned at opposite sides of the light guide plate, the bottom surface being substantially parallel to the light output surface, a plurality of microstructures formed on the light output surface, the plurality of microstructures being parallel with each other, wherein portions of the light incident surface between adjacent microstructures are defined as a roughened region.

2. The device of claim 1, wherein a number of microstructures are prisms, a cross section of each of the prisms is an isosceles triangle, the apex angle θ of the isosceles triangle is about 130°, the width W of the base of the cross section of the prism is about 21.44 micrometers (um), the height D of the cross section of the prism is about 5 um, and the distance A between two adjacent prisms is about 28.56 um.

3. The device of claim 2, wherein the prism includes two adjacent outer surfaces, the outer surface is smooth or rough.

4. The device of claim 2, wherein the width of the prism is less than the distance between two adjacent prisms.

5. The device of claim 2, wherein the cross-sectional surface of each of the microstructures can also be arc cylinder.

6. A method for manufacturing a light guide plate, comprising:
providing a mold assembly, an insert fixed on the mold assembly, the mold assembly comprising a male mold, a female mold, and the insert, the male mold affixed to the female mold to form a receiving cavity, the female mold defining a through hole at a side thereof, the insert received in the receiving cavity and attached to the male mold, wherein the insert and the male mold cooperatively form a molding cavity, the through hole being in communication with the molding cavity;
injecting a melted transparent material into the molding cavity; and
cooling the melted transparent material to form the light guide plate.

7. The method of claim 6, wherein the insert comprises a molding surface and a number of micro-recesses defined in the molding surface, each of the micro-recesses is substantially a V-shaped cutout, a number of Micro-recesses are precision machined and are parallel with each other, portions of the molding surface between adjacent Micro-recesses are roughened regions.

8. The method of claim 7, wherein a cross section of each of the micro-recesses is substantially an isosceles triangle, two inner surfaces of the micro-recesses are connected to each other, the inner surfaces of the micro-recesses are smooth and flat.

9. The method of claim 7, wherein the molding surface is corresponding to the formation of the light output surface , a number of micro-recesses correspond to formation of the prisms.

10. The method of claim 7, wherein the cross-sectional surface of each of the microstructures can also being arc shaped, and a number of microstructures are corresponding to formation of the arc cylinder.
